(19) United States
(12) Patent Application Publication
(10) Pub. No.: US 2026/0018347 A1
(43) Pub. Date: Jan. 15, 2026

(54) FORMATION ELECTROLYTE FOR TANTALUM SOLID ELECTROLYTE CAPACITORS

(71) Applicant: KEMET Electronics Corporation, Simpsonville, SC (US)

(72) Inventors: Subarna Banerjee, Simpsonville, SC (US); Ajaykumar Bunha, Simpsonville, SC (US); Antony P. Chacko, Simpsonville, SC (US); Suzune Anami, Miyagi (JP); Masami Ishijima, Miyagi (JP); Yuji Murayama, Miyagi (JP)

(21) Appl. No.: 19/338,294

(22) Filed: Sep. 24, 2025

Related U.S. Application Data
(63) Continuation-in-part of application No. 18/126,785, filed on Mar. 27, 2023.

(51) Int. Cl. H01G 9/00; H01G 9/025; H01G 9/15

(52) U.S. Cl. CPC H01G 9/0036; H01G 9/025; H01G 9/15

(57) ABSTRACT

Provided is an improved method for forming a solid electrolytic capacitor. The method includes forming a first dielectric oxide on a tantalum anode by applying a first formation electrolyte on the anode;
forming a second dielectric oxide on the first dielectric oxide by applying a second formation electrolyte on the anode;
wherein at least one of the first formation electrolyte or the second formation electrolyte comprises a derivative of inositol as defined by Formula 1:

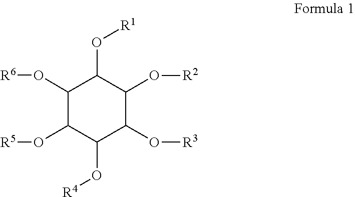

Wherein each of R¹-R⁶ is defined.

### CROSS-REFERENCE TO RELATED APPLICATIONS

The application is a Continuation-In-Part of pending U.S. patent application Ser. No. 18/126,785 filed Mar. 27, 2023, which is incorporated herein by reference.

### FIELD OF THE INVENTION

The present invention is related to an improved anodization method, for forming oxide, and electrolyte for the formation of tantalum oxide dielectric on a tantalum anode body. More specifically, the present invention is specific to a formation electrolyte comprising compounds derived from inositol which significantly improves oxide formation.

### BACKGROUND

Solid electrolytic capacitors comprising oxide formed on sintered tantalum as the anode and conductive polymer as the cathode are now utilized extensively throughout the electronics industry in virtually every application necessitating a capacitive couple in the electronic assembly. As would be fully understood by those of skill in the art, tantalum oxide (Ta₂O₅) is formed on the tantalum surface wherein the tantalum oxide functions as the dielectric between the tantalum anode and conductive polymer cathode. The process of forming tantalum oxide by subjecting the anode to voltage in the presence of an electrolyte is referred to as anodization.

Dielectric quality is a measure of electrical property of a solid electrolytic capacitor. Poor dielectric may cause failure of the part. One factor that contributes to faulty electrical properties is anomalous charge current (ACC). Parts formed in currently available anodization electrolytes exhibit high ACC wherein the high ACC is now known to be detrimental to electrolytic capacitor quality. This has led to a significant effort to develop an improved forming, or anodizing, electrolyte which provides a more stable dielectric resulting in an improved solid electrolytic capacitor, particularly with a lower ACC.

Solid electrolytic capacitors using valve metal as anodes, specifically tantalum, and conductive polymer as cathode, display anomalous charge current (ACC) which exceeds the theoretical value {l(t)} calculated as: l(t)=C*dv/dt with C being the capacitance and dV/dt being the voltage ramp}. ACC might interfere with circuit performance thereby leading to faulty capacitors as described in Y. Freeman and P. Lessner Evolution of Polymer Tantalum Capacitors Appl. Sci. 2021, 11(12), 5514-5521.

Provided herein is an improved electrolyte which is particularly suitable for use in the formation of tantalum oxide on tantalum wherein the tantalum oxide functions as an improved dielectric in a solid electrolytic capacitor.

### SUMMARY OF THE INVENTION

The present invention is related to an improved formation electrolyte which is particularly suitable for use in the formation of tantalum oxide on tantalum.

More specifically, the present invention is related to a capacitor with improved electrical properties, comprising a tantalum anode and conductive polymer cathode with an improved tantalum oxide dielectric there between.

A particular feature of the present invention is the ability to form a dielectric oxide on a tantalum anode without alteration of the manufacturing steps, equipment or procedures.

These and other advantages, as will be realized, are provided by a formation electrolyte suitable for formation of an oxide on a valve metal anode comprising a derivative of inositol defined by Formula 1:

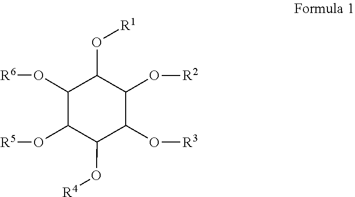

wherein:
each of R¹-R⁶ is independently selected from H, substituted or unsubstituted carbon chain of up to 20 carbon atoms, —PO₃R⁷R⁸; —SiR⁹₃, —C(O)R¹⁰; and

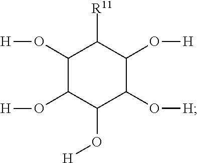

or adjacent groups may be taken together to represent —P(O)OH—O—P(O)OH—;
each R⁷ and R⁸ are independently selected from H, a cation; saturated or unsaturated carbon chain of up 35 carbon atoms; or —CH₂CHR¹²CH₂R¹³
each R⁹ is independently an alkyl of 1 to 10 carbon atoms;
each R¹⁰ is independently an alkyl of 1 to 10 carbon atoms;
each R¹¹ represents a bond to an oxygen of the derivative of inositol of Formula 1; and
R¹² and R¹³ are esters terminated with H, saturated or unsaturated carbon chain of 1 to 35 carbon atoms

Yet another embodiment is provided in a method of forming a solid electrolytic capacitor comprising:
forming a dielectric oxide on a tantalum anode by:
applying a formation electrolyte on said anode wherein said formation electrolyte comprises a derivative of inositol is defined by Formula 1:

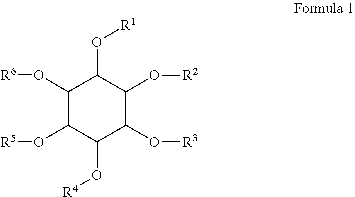

wherein:
each of R¹-R⁶ is independently selected from H, substituted or unsubstituted carbon chain of up to 20 carbon atoms, —PO₃R⁷R⁸; —SiR⁹₃, —C(O)R¹⁰; and

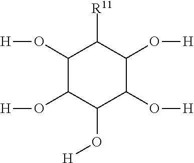

or adjacent groups may be taken together to represent —P(O)OH—O—P(O)OH—;
each R⁷ and R⁸ are independently selected from H, a cation; saturated or unsaturated carbon chain of up 35 carbon atoms; or —CH₂CHR¹²CH₂R¹³;
each R⁹ is independently an alkyl of 1 to 10 carbon atoms;
each R¹⁰ is independently an alkyl of 1 to 10 carbon atoms;
each R¹¹ represents a bond to an oxygen of the derivative of inositol of Formula 1; and
R¹² and R¹³ are esters terminated with H, saturated or unsaturated carbon chain of 1 to 35 carbon atoms; and
forming a conductive polymer cathode on said dielectric oxide.

Yet another embodiment is provided in a method of forming a solid electrolytic capacitor comprising:
forming a first dielectric oxide on a tantalum anode by applying a first formation electrolyte on the anode;
forming a second dielectric oxide on the first dielectric oxide by applying a second formation electrolyte on the anode;
wherein at least one of the first formation electrolyte or the second formation electrolyte comprises a derivative of inositol as defined by Formula 1:

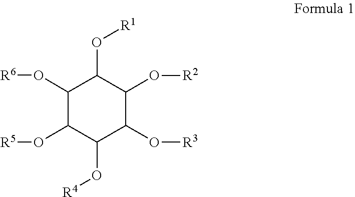

wherein:
each of R¹-R⁶ is independently selected from H, substituted or unsubstituted carbon chain of up to 20 carbon atoms, —PO₃R⁷R⁸; —SiR⁹₃, —C(O)R¹⁰; and

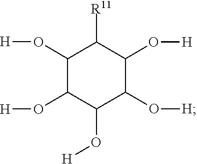

or adjacent groups may be taken together to represent —P(O)OH—O—P(O)OH—;
each R⁷ and R⁸ are independently selected from H, a cation; saturated or unsaturated carbon chain of up 35 carbon atoms; or —CH₂CHR¹²CH₂R¹³;
each R⁹ is independently an alkyl of 1 to 10 carbon atoms;
each R¹⁰ is independently an alkyl of 1 to 10 carbon atoms;
each R¹¹ represents a bond to an oxygen of the derivative of inositol of Formula 1; and
R¹² and R¹³ are esters terminated with H, saturated or unsaturated carbon chain of 1 to 35 carbon atoms; and
forming a conductive polymer cathode on said dielectric oxide.

### BRIEF DESCRIPTION OF THE DRAWINGS

FIG. 1 is a flow-chart representation of an embodiment of the invention.

FIG. 2 is a schematic cross-sectional representation of an embodiment of the invention.

FIG. 3 is a graphical representation of an advantage provided by the invention.

FIG. 4 is a graphical representation of an advantage provided by the invention.

FIG. 5 is a graphical representation of an advantage provided by the invention.

### DESCRIPTION

The present invention is related to an improved solid electrolytic capacitor comprising an improved tantalum oxide dielectric wherein the properties of the solid electrolytic capacitor, and particularly ACC, are significantly improved relative to the art. More specifically, the present invention is related to an improved formation electrolyte suitable for use in the formation of an improved tantalum oxide on a tantalum anode that yields low wet leakage. The capacitor formed with the improved tantalum oxide provides an improved solid electrolytic capacitor, particularly, when used with solid conductive polymer cathodes.

High ACC in solid electrolytic capacitors is solved by formation of tantalum oxide on a tantalum anode in an electrolyte that comprises derivatives of inositol. Without being limited to theory, it is hypothesized that the derivatives of inositol are capable of bonding with the free hydroxyl groups present on the surface of tantalum or with tantalum oxide thereby stabilizing the interface of the growing dielectric and anode which facilitates improved tantalum oxide growth.

The present invention is related to improved electrical properties in solid electrolytic capacitors and more specifically anomalous charge current (ACC). This invention provides a method of forming a dielectric oxide film on a tantalum anode and of making a solid electrolytic capacitor therewith. Formation in the inventive forming electrolyte, having free terminal O⁻ ion upon ionization, in aqueous solution, forms an improved dielectric oxide layer. Without being limited to theory, it is hypothesized that the geometry of the ions of the inventive forming electrolyte anchor to the tantalum surface, which has free hydroxyl groups. The bonding/anchoring of the ions, facilitates more electrolyte molecule access and in effect forms uniform oxide. Another hypothesis is that a portion of the inventive forming electrolyte remains on the surface of the tantalum oxide and forms a stable interface between dielectric and conductive polymer at the p-n junction. This assists in possible tunneling and significantly reduces anomalous charge current (ACC) in solid electrolytic capacitors.

Without being bound to theory, it is hypothesized that The dielectric formed by inositol derivative also exhibits fewer oxygen deficient regions near the anodized surface which provides a more ideal dielectric interface indicated by an improved ACC and leakage. Furthermore, the inositol derivative has a tendency to remain on the surface of the dielectric, even after washing, which may improve adhesion between the dielectric oxide and subsequently formed conductive polymer cathode layer.

Forming a stable dielectric interface is crucial for having stable electrical properties. The dielectric is formed by anodically oxidizing the metal anode in the electrolyte that contains the inventive forming electrolyte. Through selective control over a voltage range, the anodization process leads to a dielectric having better electrical properties which in turn leads to a capacitor having improved ACC exhibiting less anomalous charge current when charged at a constant voltage slew rate such as 100 volts/second.

The invention will be described with reference to the figures which form an integral, but non-limiting, component of the specification provided to provide clarity.

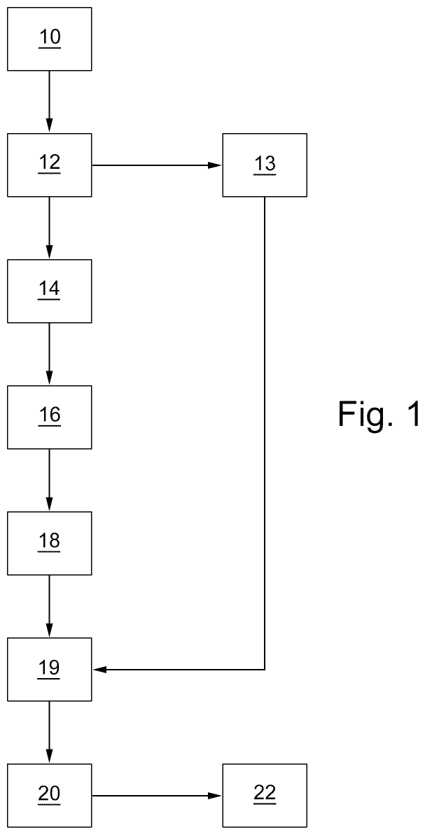

An embodiment of the invention will be described relative to FIG. 1 wherein a method for forming a solid electrolytic capacitor is illustrated in flow chart form.

In FIG. 1 an anode is provided at 10. The anode is, preferably, sintered and formed by compression of a, preferably tantalum, powder or by formation of a, preferably tantalum, film. An anode lead is preferably secured to the anode such as by a lead wire being inserted into the powder prior to compression or by attachment of a lead wire to the anode such as by welding. In the case of a film the anode lead may be a tab attached to the anode.

With further reference to FIG. 1 the anode is subjected to a first formation in a first formation electrolyte, preferably in the presence of formation voltage, at 12 thereby forming a first oxide of the anode metal on, preferably, the entire surface of the anode metal. In one embodiment the first formation electrolyte comprises a derivative of inositol as defined by Formula I discussed herein below. In another embodiment the first formation electrolyte comprises at least one compound selected from the group consisting of a derivative of inositol as defined in Formula I and phosphoric acid. In an embodiment the first oxide is heated at 14 to anneal the oxide. Heating can be in air or inert atmosphere. Heating, or annealing, is preferably done at a temperature of at least 200° C., preferably at least 250° C. more preferably at least 300° C. and preferably at no more than about 500° C.

With further reference to FIG. 1, an anode is formed in second formation electrolyte, preferably in the presence of formation voltage, at 16V thereby forming a second dielectric oxide. The second dielectric oxide is formed during second formation by filling oxygen vacancies in the first dielectric oxide without significant increase in thickness of the oxide layer. The second formation electrolyte preferably comprises a derivative of inositol as defined by Formula 1 and does comprise a derivative of inositol as defined by Formula 1 if the first formation electrolyte does not. The second formation electrolyte preferably comprises phosphoric acid. As would be realized, at least one of the formation electrolytes, first formation electrolyte or second formation electrolyte comprises the derivative of inositol as defined by Formula 1. The second formation voltage may be applied multiple times. Additional oxide layers may be formed at 18 to complete the dielectric layer which is the combination of all oxide layers on the anode.

With even further reference to FIG. 1, the oxide is optionally washed and optionally dried, 19, after which a conductive polymer cathode is formed on a portion of the dielectric layer at 20. In a preferred embodiment an external anode termination is attached to the anode or anode wire by conventional means and an external anode termination is attached to the conductive polymer cathode by conventional means at 22.

With further reference to FIG. 1, the oxidation may be a two-step process wherein the formed oxide is removed from the first formation electrolyte and introduced to a second formation electrolyte at 13 without annealing and washing. The second formation electrolyte may comprise at least one of a derivative of inositol or phosphoric acid with phosphoric acid being preferred. In a particularly preferred embodiment the first formation electrolyte comprises a derivative of inositol and the second formation electrolyte comprises phosphoric acid and the first and second oxidation step is done without annealing or washing.

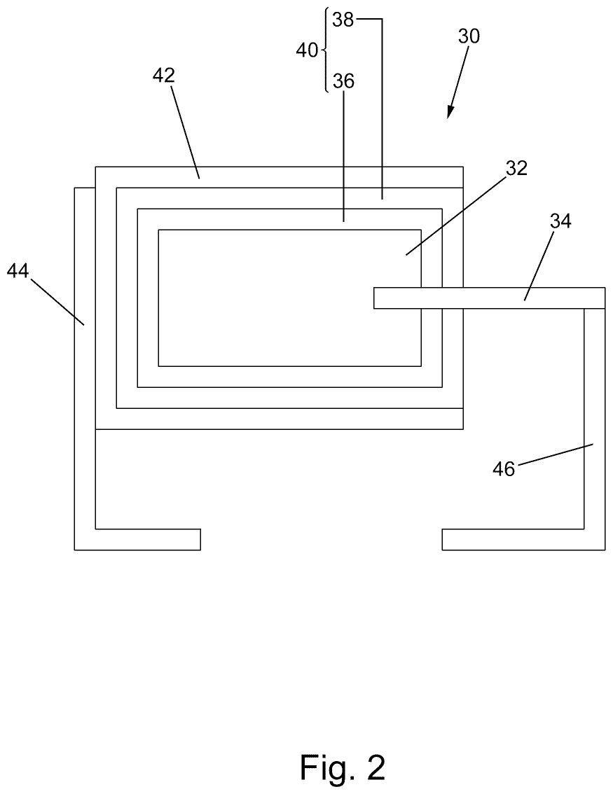

An embodiment of the invention is illustrated schematically in cross-sectional view in FIG. 2. In FIG. 2 a solid electrolytic capacitor, 30, is illustrated in schematic cross-sectional view. The solid electrolytic capacitor comprises an anode, 32, comprising an anode wire, 34, attached thereto. A first oxide, 36, encases at least a portion and preferably the entire anode. A second oxide, 38, fills in voids and deficiencies in the first oxide of at least a portion and preferably the entire first oxide wherein the first oxide and second oxide are taken together to represent the dielectric oxide, 40. The first oxide and second oxide are illustrated as distinct layers for the purposes of discussion, however, the second oxide essentially mitigates deficiencies in the first oxide layer and is not easily distinguishable, if at all, from the first oxide after formation. A conductive polymer cathode, 42, encases a portion of the dielectric oxide. An external cathode lead, 44, is attached to the conductive polymer cathode and an external anode lead, 46, is attached to the anode preferably at the anode wire.

The derivative of inositol is defined by Formula 1

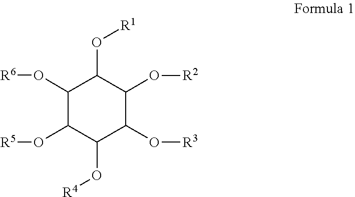

wherein:
each of R¹-R⁶ is independently selected from H, substituted or unsubstituted carbon chain of up to 20 carbon atoms, —PO₃R⁷R⁸, —SiR⁹₃, C(O)R¹⁰; and

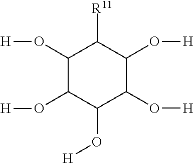

or adjacent groups may be taken together to represent —P(O)OH—O—P(O)OH—;
each R⁷ and R⁸ are independently selected from H, a cation, saturated or unsaturated carbon chain of up 35 carbon atoms; or —CH₂CHR¹²CH₂R¹³;
each R⁹ is independently an alkyl of 1 to 10 carbon atoms and preferably 1 to 3 carbon atoms with —CH₃ being particularly preferred;
each R¹⁰ is independently an alkyl of 1 to 10 carbon atoms and preferably 1 to 3 carbon atoms with —CH₃ being particularly preferred;
Each R¹¹ represents a bond to an oxygen of the derivative of inositol of Formula 1; and
R¹² and R¹³ are esters terminated with H, saturated or unsaturated carbon chain of 1 to 35 carbon atoms.

In a preferred embodiment at least one of R¹—R⁶ is PO₃R⁷R⁸ with at least one of R⁷ or R⁸ being H and preferably R⁷ and R⁸ are both H. In a more preferred embodiment at least two of R¹-R⁶ is —PO₃R⁷R⁸ with at least one of R⁷ or R⁸ being H and preferably R⁷ or R⁸ are both —H. In a more preferred embodiment at least three of R¹R⁶ is PO₃R⁷R⁸ with at least one of R⁷ or R⁸ being H and preferably R⁷ and R⁸ are both H. In a more preferred embodiment at least four of R¹-R⁶ is PO₃R⁷R⁸ with at least one of R⁷ or R⁸ being —H and preferably R⁷ and R⁸ are both H. In a more preferred embodiment at least five of R¹-R⁶ is PO₃R⁷R⁸ with at least one of R⁷ or R⁸ being H and preferably R⁷ and R⁸ are both H. In a more preferred embodiment each of R¹-R⁶ is PO₃R⁷R⁸ with at least one of R⁷ or R⁸ being —H and preferably R⁷ and R⁸ are both H.

R⁷ and R⁸ can be a cation preferably selected from quaternary amines, ammonium; metal cation, saturated or unsaturated carbon chain of up 35 carbon atoms, preferably 10-17 carbon atoms.

Substituted or unsubstituted carbon chains include alkyl chains and alkene chains which are straight chains, branched chains or cyclic which may be substituted or unsubstituted. Substitutions include ethers, —OH, carboxylic acids, phosphonic acids, phosphinic acids, esters, amines and amides.

Particularly preferred derivatives of inositol are selected from the group consisting of myo-inositol and it's isomers and their respective derivatives namely myo-inositol hexakis-phosphate (phytic acid); pentakis-, tri-, di-phosphates and their isomers; and myo-inositol mono phosphate, myo-inositol trispyrophosphate, 1-phosphatidyl-myo-inositol, 1-phosphatidyl-myo-inositol 3-phosphate, derivatives of ononitol, sequoytol, dombonitol, viscumitol, pinitol, quebrachitol, pinpollitol and brahol, myo-inositol 1,3,4,5,6-pentakis-O-(trimethylsilyl)-, bis(trimethylsilyl) phosphate, phosphatidylinositol 5-phosphate PI(5) diC8 ammonium salt, phosphatidylinositol 5-phosphate diC16 (PI(5)P diC16) sodium salt, 1,2-ciacyl-sn-glycero-3-phospho-(1-D-myo-inositol 4,5-biphosphate), phosphatidylinositol, phosphatidylinositol 3-phosphate, phosphatidylinositol 4-phosphate, phosphatidylinositol 4,5-phosphate, di-myo-inositol-phosphate, ciceritol phosphate, fagopyritol phosphate, glycosylinositol phosphryl ceramide, C25,25-Archeditylinositol, ceramide phosphoinositol, D-myo-inositol-4-hydrogen phosphate monoammonium salt and phosphatidylinositol phosphate.

The formation electrolyte may further comprise additives selected from metal salts, salts of organic acids, salts of inorganic acids, organic acids, inorganic acids, organometallic compounds, inorganic solvents, organic solvents, crosslinking agents, surface active agents, buffers and the like.

The metal salts, salts of inorganic acids and salts of organic acids included in the formation electrolyte may comprise halides, nitrides, sulfides, amides, nitrates, sulfates, phosphates, carbonates, chromates, chlorates, perchlorates, oxides, oxychlorides, peroxides, carboxylates, amides and esters.

The organic and inorganic acids included in the formation electrolyte may comprise carboxylic acids, phosphonic acids, phosphinic acids, pyrophosphoric acids, phosphoric acid, phthalic acid, maleic acid, malonic acid and trimesic acid and the like.

The organometallic compounds included in the formation electrolyte may comprise organosilanes, organoboranes, carbonyls, phosphines, crosslinking agents, surface active agents and buffers.

The solvent included in the formation electrolyte may be selected from the group consisting of water, alcohol, ethylene glycol, polyethylene glycol, tetraglyme, propylene glycol, glycol ether and alkanolamines.

The solid electrolytic capacitor comprises an anode, a cathode and a dielectric oxide between the anode and cathode. The anode is a sintered porous tantalum metal which is anodized to form the dielectric oxide. The dielectric oxide layer is covered by solid electrolyte, which is preferably a conductive polymer, which acts as cathode. The dielectric oxide is formed by subjecting the anode to voltage, in the presence of an inventive forming electrolyte in a process referred to in the art as anodization.

The solid electrolytic capacitor comprises an anode, a cathode and a dielectric oxide between the anode and cathode. The anode is a sintered porous tantalum metal which is anodized to form the dielectric oxide. The dielectric oxide layer is covered by solid electrolyte, which is preferably a conductive polymer, which acts as cathode. The dielectric oxide is formed by subjecting the anode to voltage, in the presence of an inventive forming electrolyte in a process referred to in the art as anodization.

After formation, or anodization, of the dielectric oxide on the anode, the dielectric oxide can be washed. In one embodiment the anode, with a dielectric thereon is not washed which allows residual formation electrolyte to remain anchored to the surface which facilitates bonding with the cathode layer.

Formation or anodization temperatures of about 60-125° C. are suitable for demonstration of the invention. More preferably an anodization temperature of about 75-90° C. is suitable for demonstration of the invention.

The anomalous charging current (ACC) refers to the ideal current (I ideal) in milliamps (mA) for charging a capacitor I_{ideal}=1000*C(dv/dt), C is the capacitance in Farads and dv/dt is the instantaneous rate of voltage change which is typically about 100V/S. Thus, the actual charging current remains the same or is greater than the ideal charging current (I_{ideal}). I_{actual}/I_{ideal}=1 or greater than 1.

The conductive polymer is preferably selected from a group consisting of polyanilines, polypyrroles and polythiophenes each of which may be substituted. A particularly preferred polymer comprises conjugated groups having the structure of Formula 2:

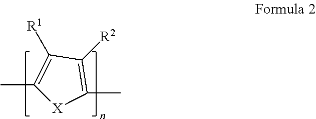

wherein:
R¹ and R² independently represent linear or branched C₁C₁₆ alkyl or C₂C₁₈ alkoxyalkyl; or are C₃-C₈ cycloalkyl, phenyl or benzyl which are unsubstituted or substituted by C₁C₆ alkyl, C₁-C₆ alkoxy, halogen or OR₃; or R¹ and R², taken together, are linear C₁-C₆ alkylene which is unsubstituted or substituted by C₁-C₆ alkyl, C₁-C₆ alkoxy, halogen, C₃-C₈ cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements. R₃ preferably represents hydrogen, linear or branched C₁-C₁₆ alkyl or C₂-C₁₈ alkoxyalkyl; or are C₃-C₈ cycloalkyl, phenyl or benzyl which are unsubstituted or substituted by C₁-C₆ alkyl;
X is S, N or O and most preferable X is S;
R¹ and R² of Formula 2 are preferably chosen to prohibit polymerization at the β-site of the ring as it is most preferred that only α-site polymerization be allowed to proceed; it is more preferred that R¹ and R² are not hydrogen and more preferably, R¹ and R² are α-directors with ether linkages being preferable over alkyl linkages; it is most preferred that the R¹ and R² are small to avoid steric interferences.

In a particularly preferred embodiment the R¹ and R² of Formula 1 are taken together to represent —O—(CHR⁴)ₙ—O— wherein:
n is an integer from 1 to 5 and most preferably 2;
R⁴ is independently selected from hydrogen; a linear or branched C₁ to C₁₈ alkyl radical C to C₁₂ cycloalkyl radical, C to C₁₄ aryl radical C to C₁₈ aralkyl radical or C₁ to C₄ hydroxyalkyl radical, optionally substituted with a functional group selected from carboxylic acid, hydroxyl, amine, substituted amines, alkene, acrylate, thiol, alkyne, azide, sulfate, sulfonate, sulfonic acid, imide, amide, epoxy, anhydride, silane, and phosphate; hydroxyl radical; or R⁴ is selected from —(CHR⁵)ₐ—R¹⁶; —O(CHR⁵)ₐR¹⁶; —CH₂O(CHR⁵)ₐR¹⁶; —CH₂O(CH₂CHR⁵O)ₐR¹⁶, or
R⁴ is a functional group selected from the group consisting of hydroxyl, carboxyl, amine, epoxy, amide, imide, anhydride, hydroxymethyl, alkene, thiol, alkyne, azide, sulfonic acid, benzene sulfonic sulfonate, SO₃M, anhydride, silane, acrylate and phosphate;
R⁵ is H or alkyl chain of 1 to 5 carbon atoms optionally substituted with a functional group selected from carboxylic acid, hydroxyl, amine, alkene, thiol, alkyne, azide, epoxy, acrylate and anhydride;
R¹⁶ is H or SO₃M or an alkyl chain of 1 to 5 carbon atoms optionally substituted with a functional group selected from carboxylic acid, hydroxyl, amine, substituted amines, alkene, thiol, alkyne, azide, amide, imide, sulfate, SO₃M, amide, epoxy, anhydride, silane, acrylate and phosphate;
a is integer from 0 to 10; and
M is a H or cation preferably selected from ammonia, sodium or potassium.

The conducting polymer can be either a water-soluble or water-dispersible compound. Examples of such a π conjugated conductive polymer include polypyrrole or polythiophene. Particularly preferred conductive polymers include poly(3,4-ethylenedioxythiophene), poly(4-(2,3-dihydrothieno-[3,4-b][1,4]dioxin-2-yl)methoxy)-1-butane-sulphonic acid, salt), poly(4-(2,3-dihydrothieno-[3,4-b][1,4]dioxin-2-yl)methoxy)-1-propane-sulphonic acid, salt), poly(4-(2,3-dihydrothieno-[3,4-b][1,4]dioxin-2-yl)methoxy)-1-methyl-1-propane-sulphonic acid, salt), poly(4-(2,3-dihydrothieno-[3,4-b][1,4]dioxin-2-yl)methoxy alcohol, poly(N-methylpyrrole), poly(3-methylpyrrole), poly(3-octylpyrrole), poly(3-decylpyrrole), poly(3-dodecylpyrrole), poly(3,4-dimethylpyrrole), poly(3,4-dibutylpyrrole), poly(3-carboxypyrrole), poly(3-methyl-4-carboxypyrrole), poly(3-methyl-4-carboxyethylpyrrole), poly(3-methyl-4-carboxybutylpyrrole), poly(3-hydroxypyrrole), poly(3-methoxypyrrole), polythiophene, poly(3-methylthiophene), poly(3-hexylthiophene), poly(3-heptylthiophene), poly(3-octylthiophene), poly(3-decylthiophene), poly(3-dodecylthiophene), poly(3-octadecylthiophene), poly(3-bromothiophene), poly(3,4-dimethylthiophene), poly(3,4-dibutylthiophene), poly(3-hydroxythiophene), poly(3-methoxythiophene), poly(3-ethoxythiophene), poly(3-butoxythiophene), poly(3-hexyloxythiophene), poly(3-heptyloxythiophene), poly(3-octyloxythiophene), poly(3-decyloxythiophene), poly(3-dodecyloxythiophene), poly(3-octadecyloxythiophene), poly(3,4-dihydroxythiophene), poly(3,4-dimethoxythiophene), poly(3,4-ethylenedioxythiophene), poly(3,4-propylenedioxythiophene), poly(3,4-butenedioxythiophene), poly(3-carboxythiophene), poly(3-methyl-4-carboxythiophene), poly(3-methyl-4-carboxyethylthiophene), poly(3-methyl-4-carboxybutylthiophene), polyaniline, poly(2-methylaniline), poly(3-isobutylaniline), poly(2-aniline sulfonate), poly(3-aniline sulfonate), and the like.

Co-polymers composed at least two different copolymerized monomers are contemplated. Co-polymers comprise at least one polymerized monomer selected from the group consisting of polypyrrole, polythiophene, poly(4-(2,3-dihydrothieno-[3,4-b][1,4]dioxin-2-yl)methoxy)-1-butane-sulphonic acid, salt), poly(4-(2,3-dihydrothieno-[3,4-b][1,4]dioxin-2-yl)methoxy)-1-methyl-1-propane-sulphonic acid, salt), poly(N-methylpyrrole), poly(3-methylthiophene), poly(3-methoxythiophene), and poly(3,4-ethylenedioxythiophene).

A particularly preferred conductive polymer is poly-3,4-polyethylene dioxythiophene (PEDOT).

The conductive polymer layer can be formed on the dielectric by any technique commonly employed in the art. The conductive polymer can be formed into a slurry and deposited onto the surface. Alternatively, the conductive polymer can be added as monomer and polymerized in-situ as well known in the art.

It is known in the art to additional layers to the cathode to facilitate soldering of the cathode to a lead frame or circuitry. Carbon containing layers and metal containing layers are well known and well documented in the art and further discussion is not warranted herein.

Organofunctional silanes and organic compounds with more than one crosslinking group, especially more than one epoxy group, are particularly suitable for use in combination with the inventive formation electrolyte. The formation electrolyte may include the organofunctional silanes and organic compounds with more than one crosslinking group as additive in combination with inositol derivative. After formation of the dielectric oxide the anode with dielectric thereon can be washed. In an embodiment the anode with dielectric thereon is not washed which allows residual organofunctional silanes and organic compounds with more than one crosslinking group together with inositol derivative to be present during formation of the cathode.

An exemplary organofunctional silane is defined by the formula:

XR₁Si(R₃)₃₋ₙ(R₂)ₙ

wherein X is an organic functional group such as amino, epoxy, anhydride, hydroxy, mercapto, sulfonate, carboxylate, phosphonate, halogen, vinyl, methacryloxy, ester, alkyl etc; R₁ is an aryl or alkyl (CH₂)ₘ wherein m can be 0 to 14; R₂ is individually a hydrolysable functional group such as alkoxy, acyloxy, halogen, amine or their hydrolyzed product; R₃ is individually an alkyl functional group of 1-6 carbon atoms; n is 1 to 3.

The organofunctional silane can also be dipodal, define by the formula:

Y(Si(R₃)₃₋ₙ(R₂)ₙ)₂

wherein Y is any organic moiety that contains reactive or nonreactive functional groups, such as alkyl, aryl, sulfide or melamine; R₃, R₂ and n are defined above. The organofunctional silane can also be multi-functional or polymeric silanes, such as silane modified polybutadiene, or silane modified polyamine, etc.

Examples of organofunctional silane include 3-glycidoxypropyltrimethoxysilane, 3-aminopropytriethoxysilane, aminopropylsiIanetriol, (triethoxysilyl)propylsuccinic anhydride, 3-mercaptopropyltrimethoxysilane, vinyltrimethoxysilane, 3-methacryloxypropyltrimethoxysilane, 3-trihydroxysilyl-1-propane sulfonic acid, octyltriethyoxysilane, bis(triethoxysilyl)octane, etc. The examples are used to illustrate the invention and should not be regarded as conclusiveExamples of organofunctional silane include 3-glycidoxypropyltrimethoxysilane, 3-aminopropytriethoxysilane, aminopropylsilanetriol, (triethoxysily)propylsuccinic anhydride, 3-mercaptopropyltrimethoxysilane, vinyltrimethoxysilane, 3-methacryloxypropyltrimethoxysilane, 3-trihydroxysilyl-1-propane sulfonic acid, octyltriethyoxysilane, bis(triethoxysilyl)octane, etc. The examples are used to illustrate the invention and should not be regarded as conclusive.

A particularly preferred organofunctional silane is glycidyl silane defined by the formula:

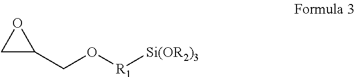

wherein R₁ is an alkyl of 1 to 14 carbon atoms and more preferably selected from methyl ethyl and propyl; and each R₂ is independently an alkyl or substituted alkyl of 1 to 6 carbon atoms.

A particularly preferred glycidyl silane is 3-glycidoxypropyltrimethoxysilane defined by the formula:

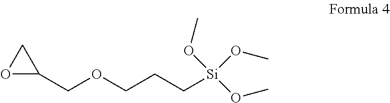

which is referred to herein as “Silane A” for convenience.

A particularly suitable organometallic is neoalkoxy titanate with titanium IV 2,2(bis 2-propenolatomethyl)butanolato, tris neodecanoato-O; titanium IV 2,2(bis 2-propenolatomethyl)butanolato, iris(dodecyl)benzenesulfonato-O; titanium IV 2,2(bis 2-propenolatomethyl)butanolato, tris(dioctyl)phosphato-O; titanium IV 2,2(bis 2-propenolatomethyl)tris(dioctyl)pyrophosphatobutanolato-O; titanium IV 2,2(bis 2-propenolatomethyl)butanolato, tris(2-ethylenediamino)ethylato; and titanium IV 2,2(bis 2-propenolatomethyl)butanolato, tris(3-amino)phenylato being representative neoalkoxy titanates and derivatives thereof.

A crosslinker with at least two epoxy groups is referred to herein as an epoxy crosslinking compound and is defined by the formula:

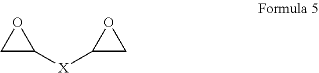

wherein the X is an alkyl or substituted alkyl of 0-14 carbon atoms, preferably 0-6 carbon atoms; an aryl or substituted aryl, an ethylene ether or substituted ethylene ether, polyethylene ether or substituted polyethylene ether with 2-20 ethylene ether groups or combinations thereof. A particularly preferred substitute is an epoxy group.

Examples of epoxy crosslinking compounds having more than one epoxy groups include ethylene glycol diglycidyl ether (EGDGE), propylene glycol diglycidyl ether (PGDGE), 1,4-butanediol diglycidyl ether (BDDGE), pentylene glycol diglycidyl ether, hexylene glycol diglycidyl ether, cyclohexane dimethanol diglycidyl ether, resorcinol glycidyl ether, glycerol diglycidyl ether (GDGE), glycerol polyglycidyl ethers, diglycerol polyglycidyl ethers, trimethylolpropane polyglycidyl ethers, sorbitol diglycidyl ether (Sorbitol-DGE), sorbitol polyglycidyl ethers, polyethylene glycol diglycidyl ether (PEGDGE), polypropylene glycol diglycidyl ether, polytetramethylene glycol diglycidyl ether, di(2,3-epoxypropyl)ether, 1,3-butadiene diepoxide, 1,5-hexadiene diepoxide, 1,2,7,8-diepoxyoctane, 1,2,5,6-diepoxycyclooctane, 4-vinyl cyclohexene diepoxide, bisphenol A diglycidyl ether, maleimide-epoxy compounds, etc.

### EXAMPLES

Wet capacitance and leakage are measured by an LCR meter in 25 wt % phosphoric acid in water under a test frequency of 120 Hz and test voltage of 70% of voltage. For wet leakage, the parts have been tested after a charge time of 120 seconds and DC bias voltage of 2V. ACC (anomalous charging current) is measured at the end of the production process. The finished parts are mounted on a circuit board and measurement is done at 0° C. with 100V/sec ramp and 80% Vr and expressed as times theoretical value (xTLV) or Current(mA) at compliance voltage.

Comparative Example 1: Tantalum anodes (330 microfarads, 16V rated voltage) are prepared by sintering of tantalum powder. First, the anodes are anodized in an electrolyte that works as a control which is phosphoric acid about (2-5 wt %), ethylene glycol (50-70 wt %) and water having resistivity of about (100-370) Ohm-cm measured at 80° C.} at 35V and 80° C. to form a dielectric oxide on the tantalum anode (1^{st} anodization). The anodes are rinsed, heat-treated at 450° C. for 30 minutes and re-anodized to fill in the oxygen vacancies created during heat treatment to form a robust dielectric in the original electrolyte. Wet leakage after 1^{st} anodization is given in Table 1. The anodes are then covered in conductive polymer that serve as cathode, followed by carbon and silver coatings. Parts get assembled and molded into surface mount finished capacitors using known techniques. ACC is measured at 0° C. on mounted parts and reported as current in mA at 12.8V {80% of the rated voltage (Vr)}. Cap and ESR (equivalent series resistance) of the finished part are also reported along with ACC in Table 1.

Inventive Example 1: A series of solid electrolytic capacitors have been prepared in a similar manner to that in Comparative Example 1 using 330 microfarad parts with rated voltage 16V except that the electrolyte is (5-10 wt %) inositol-6-phosphate in water having resistivity (7-15) ohm-cm at 80° C. Wet leakage after 1^{st} anodization, cap and ESR of finished part are also reported along with ACC as current (mA) at 12.8V (80% of Vr) are given in Table 1.

Inventive Example 2: A series of solid electrolytic capacitors are prepared in similar manner to that in Inventive Example 1 using 330 microfarad parts with rated voltage 16V except that the anodization electrolyte is a mixture of (5-10 wt %) inositol-6-phosphate and epoxy silane (1:1) in water having resistivity (9-17) Ohm-cm at 80° C. Wet leakage after 1^{st} anodization, cap and ESR of finished part are also reported along with ACC as current (mA) at 12.8V (80% of Vr) are given in Table 1.

Inventive Example 3: In this example, a series of solid electrolytic capacitors are prepared in similar manner to that in Inventive Example 1 using 330 microfarad parts with rated voltage 16V except that the electrolyte has ethylene glycol (EG) added to it. Inositol-6-phosphate (5-10 wt %) is added to ethylene glycol (50-70 wt %) in water having resistivity (75-100) ohm-cm at 80° C. Wet leakage after 1^{st} anodization, cap and ESR of finished part are also reported along with ACC as current (mA) at 12.8V (80% of Vr) are given in Table 1.

Inventive Example 4: In this example, a series of solid electrolytic capacitors are prepared in similar manner using 300 microfarad parts with rated voltage 16V to that in Inventive Example 2 except that the polymer also has the same electrolyte used in Inventive Example 2 along with conductive polymer. Wet leakage after 1^{st} anodization, cap and ESR of finished part are also reported along with ACC as current (mA) at 12.8V (80% of Vr) are given in Table 1.

Wet leakage after 1^{st} anodization on, cap and ESR of finished part are also reported along with ACC as current (mA) at compliance voltage, 12.8V (80% of Vr) are given in Table 1.

TABLE 1

| | | | Equivalent | |
|---|---|---|---|---|
| | Wet leakage | | Series | Current(mA) at |
| | (nano | Capacitance | resistance | compliance |
| Example | amperes/CV) | (microfarad) | (ohms) | voltage (12.8 V) |
| Comparative | 1.5 | 310 | 0.0274 | 496 |
| Example | | | | |
| Inventive | 0.5 | 288 | 0.0281 | 55 |
| Example 1 | | | | |
| Inventive | 0.6 | 296 | 0.0282 | 58 |
| Example 2 | | | | |
| Inventive | 1.07 | 288 | 0.0292 | 93.5 |
| Example 3 | | | | |
| Inventive | 0.6 | 306 | 0.0315 | 42.9 |
| Example 4 | | | | |

The inventive examples demonstrated the ability to form a capacitor, using the inventive formation electrolyte, having an anomalous charge current less than 4 times the theoretical value. This is otherwise not available in the art.

Comparative Example 3 Tantalum anodes (330 microfarads, 16V rated voltage) are prepared by sintering of tantalum powder. First, the anodes are anodized in phosphoric acid. The anodes are rinsed, heat-treated at 450° C. for 30 minutes and re-anodized (second formation) in phosphoric acid. The anodes are then covered in conductive polymer that served as cathode, followed by carbon and silver coatings. Parts get assembled and molded into surface mounted finished capacitors using known techniques. ACC is measured at 0° C. on mount parts and reported as current in mA at 12.8V {80% of the rated voltage (Vr)}. Cap and ESR (equivalent series resistance) of the finished part are also reported along with ACC in Table 2.

Inventive Example 5 Tantalum anodes (330 microfarads, 16V rated voltage) are prepared by sintering of tantalum powder. First, the anodes are anodized in 0.5 wt % inositol-6-phosphate. The anodes are rinsed, heat-treated at 450° C. for 30 minutes and re-anodized (second formation) in 1.0 wt % phosphoric acid. The anodes are then covered in conductive polymer that served as cathode, followed by carbon and silver coatings. Parts get assembled and molded into surface mount finished capacitors using known techniques. ACC is measured at 0° C. on mounted parts and reported as current in mA at 12.8V {80% of the rated voltage (Vr)}. Cap and ESR (equivalent series resistance) of the finished part are also reported along with ACC in Table 2.

TABLE 2

| | | | Equivalent | Current(mA) |
|---|---|---|---|---|
| | Wet leakage | | Series | at compliance |
| | (nano | Capacitance | resistance | voltage |
| Example | amperes/CV) | (microfarad) | (ohms) | (12.8 V) |
| Comparative | 2.2 | 312 | 0.02675 | 733 |
| Example 3 | | | | |
| Inventive | 0.9 | 283 | 0.02451 | 296 |
| Example 5 | | | | |

The results presented in Table 2 illustrate the advantages of first formation in a derivative of inositol and second formation in phosphoric acid.

A series of tantalum anode foils were anodized in sequential steps. The forming electrolytes were 1.0 wt % phosphoric acid and 0.5 wt % inositol-6-phosphate with each having equivalent resistivity. Each sample is anodized for a total of 5 hours at 80° C. at 30 volts.

Comparative Example 2 (C2) is anodized in phosphoric acid exclusively.

Inventive Example 6 (I6) is anodized in inositol-6-phosphate exclusively without annealing between oxidation steps but with washing and drying.

Inventive Example 7 (I7) is anodized for 2.5 hours in phosphoric acid without annealing but with washing and drying (no annealing-only wash and dry) followed by anodization in inositol-6-phosphate for 2.5 hours.

Inventive Example 8 (I8) is anodized in inositol-6-phosphate for 2.5 hours without annealing but with washing and drying followed by anodization in phosphoric acid for 2.5 hours.

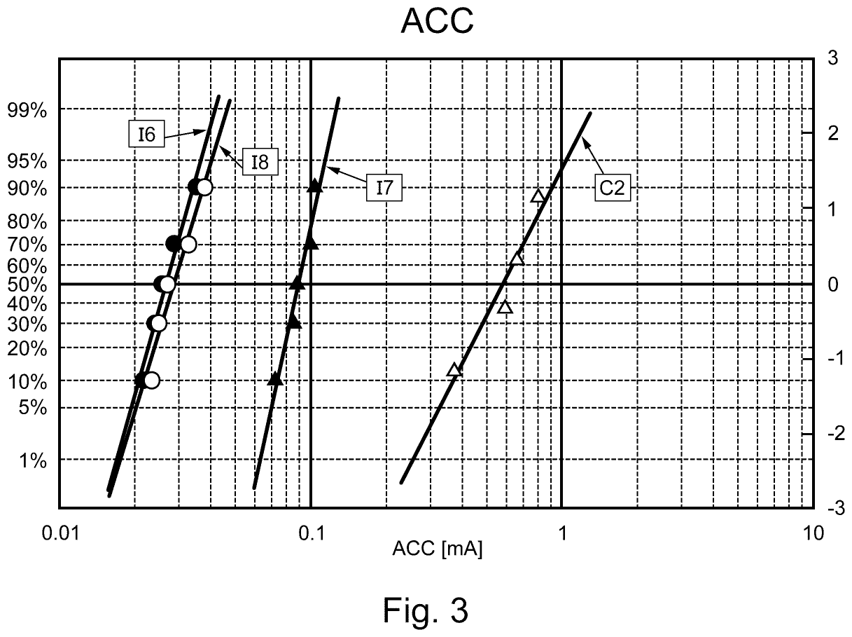

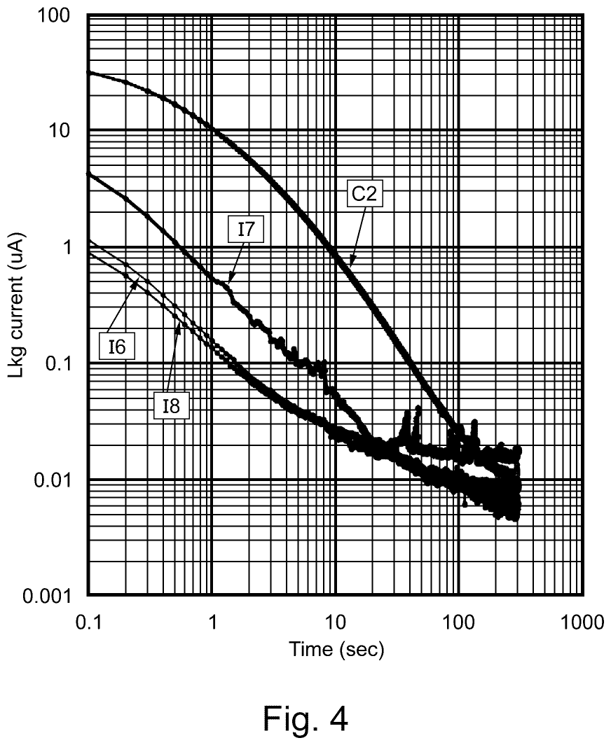

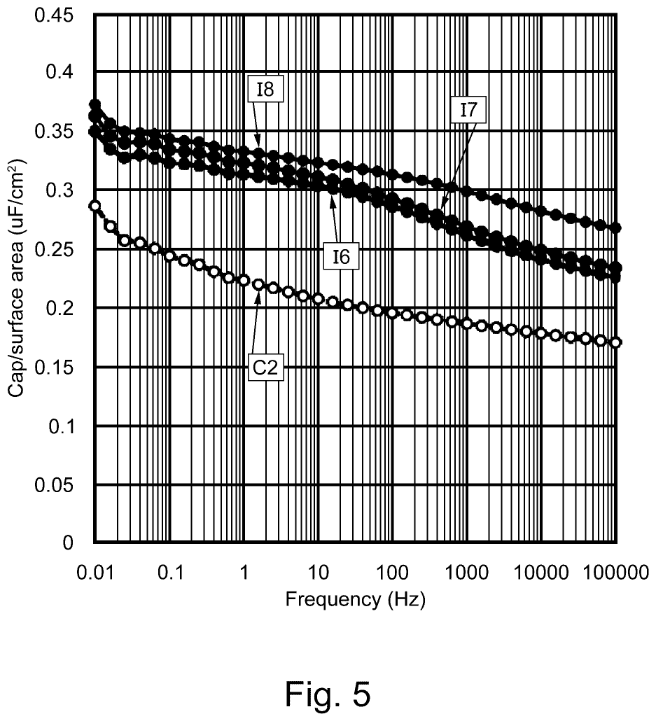

ACC after reflow at 240° C., measured at 15V and 33.3V/sec is illustrated graphically in FIG. 3. I-t after reflow at 240° C. at 15V is illustrated graphically in FIG. 4. Capacitance {measured as a function of surface area (μF/cm²)} vs frequency plot is illustrated in FIG. 5. The results clearly indicate that oxide formation, or anodization, utilizing derivatives of inositol provide an improved dielectric.

The invention has been described with reference to preferred embodiments without limit thereto. One of skill in the art would realize additional embodiments which are described and set forth in the claims appended hereto.

1. A method of forming a solid electrolytic capacitor comprising:
forming a first dielectric oxide on a tantalum anode by applying a first formation electrolyte on said anode;
forming a second dielectric oxide on said first dielectric oxide by applying a second formation electrolyte on said anode;
wherein at least one of said first formation electrolyte or said second formation electrolyte comprises a derivative of inositol as defined by Formula 1: 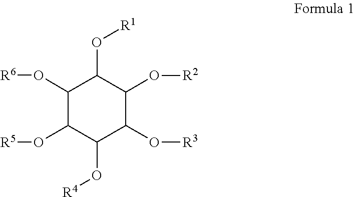
wherein:
each of R¹-R⁶ is independently selected from H, substituted or unsubstituted carbon chain of up to 20 carbon atoms, —PO₃R⁷R⁸; —SiR⁹₃, —C(O)R¹⁰; and 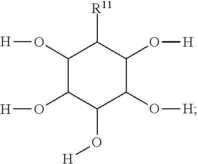
or adjacent groups may be taken together to represent 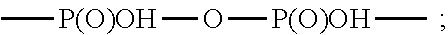
each R⁷ and R⁸ are independently selected from H, a cation; saturated or unsaturated carbon chain of up 35 carbon atoms; or —CH₂CHR¹²CH₂R¹³;
each R⁹ is independently an alkyl of 1 to 10 carbon atoms;
each R¹⁰ is independently an alkyl of 1 to 10 carbon atoms;
each R¹¹ represents a bond to an oxygen of the derivative of inositol of Formula 1; and
R¹² and R¹³ are esters terminated with H, saturated or unsaturated carbon chain of 1 to 35 carbon atoms and
forming a conductive polymer cathode on said dielectric oxide.

2. The method of forming a solid electrolytic capacitor of claim 1 where the first formation is done by step formation.

3. The method of forming a solid electrolytic capacitor of claim 2 where the step of first formation involves forming with two electrolytes sequentially where at least one electrolyte is an inositol derivate.

4. The method of forming a solid electrolytic capacitor of claim 1 further comprising application of voltage to said anode during said applying said first formation electrolyte or said applying said second formation electrolyte.

5. The method of forming a solid electrolytic capacitor of claim 1 wherein said first formation electrolyte comprises said derivative of inositol.

6. The method of forming a solid electrolytic capacitor of claim 1 wherein said second formation electrolyte comprises said derivative of inositol.

7. The method of forming a solid electrolytic capacitor of claim 1 wherein one of said first formation electrolyte or said second formation electrolyte further comprises phosphoric acid.

8. The method of forming a solid electrolytic capacitor of claim 1 wherein at least one of R¹-R⁶ is —PO₃R⁷R⁸ with at least one of R⁷ or R⁸ being —H.

9. The method of forming a solid electrolytic capacitor of claim 8 wherein R⁷ and R⁸ are both —H.

10. The method of forming a solid electrolytic capacitor of claim 8 wherein at least two of R¹-R⁶ is —PO₃R⁷R⁸.

11. The method of forming a solid electrolytic capacitor of claim 10 wherein at least three of R¹-R⁶ is —PO₃R⁷R⁸.

12. The method of forming a solid electrolytic capacitor of claim 11 wherein at least four of R¹-R⁶ is —PO₃R⁷R⁸.

13. The method of forming a solid electrolytic capacitor of claim 12 wherein at least five of R¹-R⁶ is —PO₃R⁷R⁸.

14. The method of forming a solid electrolytic capacitor of claim 13 wherein each of R¹-R⁶ is —PO₃R⁷R⁸.

15. The method of forming a solid electrolytic capacitor of claim 14 with each R⁷ and R⁸ is —H.

16. The method of forming a solid electrolytic capacitor of claim 1 wherein at least one R⁷ or R⁸ is a cation.

17. The method of forming a solid electrolytic capacitor of claim 1 wherein said cation is selected from the group consisting of quaternary amines and saturated or unsaturated carbon chain of up 35 carbon atoms.

18. The method of forming a solid electrolytic capacitor of claim 1 wherein each R⁹ is independently an alkyl of 1 to 3 carbon atoms.

19. The method of forming a solid electrolytic capacitor of claim 18 wherein each R⁹ is —CH₃.

20. The method of forming a solid electrolytic capacitor of claim 1 wherein each R¹⁰ is independently an alkyl of 1 to 3 carbon atoms.

21. The method of forming a solid electrolytic capacitor of claim 20 wherein each R¹⁰ is —CH₃.

22. The method of forming a solid electrolytic capacitor of claim 1 wherein said derivative of inositol is selected from the group consisting of myo-inositol and it's isomers and their respective derivatives namely myo-inositol hexakis phosphate (phytic acid); pentakis-, tri-, di-phosphates and their isomers; and myo-inositol mono phosphate, myo-inositol trispyrophosphate, 1-phosphatidyl-myo-inositol, 1-phosphatidyl-myo-inositol 3-phosphate, derivatives of ononitol, sequoytol,dombonitol, viscumitol, pinitol, quebrachitol, pinpollitol and brahol, myo-inositol 1,3,4,5,6-pentakis-O-(trimethylsilyl)-, bis(trimethylsilyl) phosphate, phosphatidylinositol 5-phosphate PI(5) diC8 ammonium salt, phosphatidylinositol 5-phosphate diC16 (PI(5)P diC16) sodium salt, 1,2-ciacyl-sn-glycero-3-phospho-(1-D-myo-inositol 4,5-biphosphate), phosphatidylinositol, phosphatidylinositol 3-phosphate, phosphatidylinositol 4-phosphate, phosphatidylinositol 4,5-phosphate, di-myo-inositol-phosphate, ciceritol phosphate, fagopyritol phosphate, glycosylinositol phosphryl ceramide, C25,25-Archeditylinositol, ceramide phosphoinositol, D-myo-inositol-4-hydrogen phosphate monoammonium salt and phosphatidylinositol phosphate.

23. The method of forming a solid electrolytic capacitor of claim 1 wherein said formation electrolyte comprises additives selected from metal salts, salts of organic acids, salts of inorganic acids, organic acids, inorganic acids, organometallic compounds, inorganic solvents, organic solvents, crosslinking agents, surface active agents and buffers.

24. The method of forming a solid electrolytic capacitor of claim 23 wherein said metal salts, salts of inorganic acids and salts of organic acids comprise halides, nitrides, sulfides, amides, nitrates, sulfates, phosphates, carbonates, chromates, chlorates, perchlorates, oxides, oxychlorides, peroxides, carboxylates, amides and esters.

25. The method of forming a solid electrolytic capacitor of claim 23 wherein said organic and inorganic acids comprise carboxylic acids, phosphonic acids, phosphinic acids, phosphoric acid, phthalic acid, maleic acid, malonic acid and trimesic acid.

26. The method of forming a solid electrolytic capacitor of claim 23 wherein said organometallic compounds comprise organosilanes, organoboranes, carbonyls, phosphines, crosslinking agents, surface active agents and buffers.

27. The method of forming a solid electrolytic capacitor of claim 1 wherein said formation electrolyte further comprises at least one solvent selected from the group consisting of water, alcohol, ethylene glycol, polyethylene glycol, tetraglyme, propylene glycol, glycol ether and alkanolamines.

28. The method of forming a solid electrolytic capacitor of claim 1 wherein said conductive polymer is selected from the group consisting of poly(3,4-ethylenedioxythiophene), poly(4-(2,3-dihydrothieno-[3,4-b][1,4]dioxin-2-yl)methoxy)-1-butane-sulphonic acid, salt), poly(4-(2,3-dihydrothieno-[3,4-b][1,4]dioxin-2-yl)methoxy)-1-propane-sulphonic acid, salt), poly(4-(2,3-dihydrothieno-[3,4-b][1,4]dioxin-2-yl)methoxy)-1-methyl-1-propane-sulphonic acid, salt), poly(4-(2,3-dihydrothieno-[3,4-b][1,4]dioxin-2-yl)methoxy alcohol, poly(N-methylpyrrole), poly(3-methylpyrrole), poly(3-octylpyrrole), poly(3-decylpyrrole), poly(3-dodecylpyrrole), poly(3,4-dimethylpyrrole), poly(3,4-dibutylpyrrole), poly(3-carboxypyrrole), poly(3-methyl-4-carboxypyrrole), poly(3-methyl-4-carboxyethylpyrrole), poly(3-methyl-4-carboxybutylpyrrole), poly(3-hydroxypyrrole), poly(3-methoxypyrrole), polythiophene, poly(3-methylthiophene), poly(3-hexylthiophene), poly(3-heptylthiophene), poly(3-octylthiophene), poly(3-decylthiophene), poly(3-dodecylthiophene), poly(3-octadecylthiophene), poly(3-bromothiophene), poly(3,4-dimethylthiophene), poly(3,4-dibutylthiophene), poly(3-hydroxythiophene), poly(3-methoxythiophene), poly(3-ethoxythiophene), poly(3-butoxythiophene), poly(3-hexyloxythiophene), poly(3-heptyloxythiophene), poly(3-octyloxythiophene), poly(3-decyloxythiophene), poly(3-dodecyloxythiophene), poly(3-octadecyloxythiophene), poly(3,4-dihydroxythiophene), poly(3,4-dimethoxythiophene), poly(3,4-ethylenedioxythiophene), poly(3,4-propylenedioxythiophene), poly(3,4-butenedioxythiophene), poly(3-carboxythiophene), poly(3-methyl-4-carboxythiophene), poly(3-methyl-4-carboxyethylthiophene), poly(3-methyl-4-carboxybutylthiophene), polyaniline, poly(2-methylaniline), poly(3-isobutylaniline), poly(2-aniline sulfonate), poly(3-aniline sulfonate).

29. The method of forming a solid electrolytic capacitor of claim 1 wherein said dielectric is not washed prior to said forming of said conductive polymer cathode.

30. A capacitor comprising an anode prepared by anodizing a pressed valve metal powder in the electrolytic solution of claim 1.

31. The capacitor of claim 30 wherein said conductive polymer layer comprises an internal polymer layer and an external polymer layer and said internal and external polymer comprise pre-polymerized conductive polymer.

32. The capacitor of claim 30 having an anomalous charge current less than 4 times the theoretical value.
